(19) United States
(12) Patent Application Publication
(10) Pub. No.: US 2025/0365248 A1
(43) Pub. Date: Nov. 27, 2025

(54) METHOD AND ELECTRONIC DEVICE FOR DATA PACKET FLOW DISTRIBUTION IN MULTI-CORE PROCESSOR

(71) Applicant: Samsung Electronics Co., Ltd., Suwon-si (KR)

(72) Inventors: Srihari Das SUNKADA GOPINATH, Bangalore (IN); Vasudev YADAV, Bangalore (IN); Kopparty Veera Venkata Satya Seeta Rama VIJAYKRISH, Bangalore (IN)

(21) Appl. No.: 19/292,411

(22) Filed: Aug. 6, 2025

Related U.S. Application Data
(63) Continuation of application No. PCT/KR2023/005327, filed on Apr. 19, 2023.

(30) Foreign Application Priority Data
Feb. 21, 2023 (IN) 202341011607

(51) Int. Cl. H04L 47/62; H04L 43/16

(52) U.S. Cl. CPC H04L 47/62; H04L 43/16

(57) ABSTRACT

A method for data packet flow distribution in a multi-core processor by an electronic device is provided. The method includes receiving, by the electronic device, at least one data packet to be processed by the multi-core processor, determining, by the electronic device, whether a flow lock of a critical section of a data flow is acquired at a core, determining, by the electronic device, whether a threshold number of data packet from a flow queue is processed at the core upon successful flow lock acquisition, determining, by the electronic device, pending data packet to be processed in the flow queue upon processing the threshold number of data packet from the flow queue, creating, by the electronic device, a new trigger packet or event upon determining the pending data packet to be processed in the flow queue, releasing, by the electronic device, the flow lock of the critical section, and enqueuing the new trigger packet or event to a generic queue to be processed by other cores of the multi-core processor.

### CROSS-REFERENCE TO RELATED APPLICATION(S)

This application is a continuation application, claiming priority under 35 U.S.C. § 365 (c), of an International application No. PCT/KR2023/005327, filed on Apr. 19, 2023, which is based on and claims the benefit of an Indian Patent Application number 202341011607, filed on Feb. 21, 2023, in the Indian Intellectual Property Office, the disclosure of which is incorporated by reference herein in its entirety.

### BACKGROUND

### 1. Field

The disclosure relates to an electronic device. More particularly, the disclosure relates to a method and the electronic device for data packet flow distribution in a multi-core processor.

### 2. Description of Related Art

Usage of a multi-core processor has ubiquitous increased for the performance gain in electronic devices. The multi-core processor handles multiple event or packet of multiple data flows. Each core of the multi-core processor subscribes to a list of queues or rings from which each core receives event or packet. Data plane event or packet processing of the flow is subdivided into non-critical section processing and a critical section processing to maximize parallel processing and improve system throughput. The critical section processing of the flow needs to be handled sequentially with a flow specific critical section lock called as a flow lock (i.e. critical section flow lock). A critical section is a section of event or packet processing of the flow, which has to be executed by one core only once at a time. Sequence number assignment, flow specific state variables upgradation are examples for the critical section. The critical section of each flow, for example, is protected by the flow lock, so that the multiple parallel cores do not execute or process the critical section simultaneously. The non-critical section processing of the flow is done by multiple cores of the multi-core processor in parallel. A non-critical section is an event or packet processing section that may be processed by the multiple cores in parallel for the flow. Examples for the non-critical section are checking the validity of an event or packet, processing and removal of network headers, transmitting the event or packet out, etc.

Hardware scheduler and software scheduler are two types of schedulers available for event or packet distribution across the cores of the multi-core processor based on a queue or ring subscription. Each core may poll on a desired list of queues or rings and obtains the event or packet to process. The core identifies each event or packet based on the flow identifier (ID). Each core identifies the flow based on the content of packet (e.g. a call ID or a bearer ID in the packet). Each core continuously polls for the event or packet from the multiple queues or rings or the hardware scheduler or the software scheduler. If one core gets the event or packet containing the critical section to process, then the core tries to acquire the flow lock called as try lock. If the core successfully acquired the flow lock, then the core continues to process the critical section of the event or packet.

Failure in acquiring the flow lock means some other core must be holding the critical section lock of the flow, and core failing to acquire lock enqueues the event or packet to flow queue. Each flow queue is located at memory of the electronic devices to be accessed based on a flow ID. The flow queue is a queue for each flow that manages pending event or packet for critical section processing. Enqueuing and dequeuing from the flow queue is done with the flow queue lock to avoid multiple cores from trying to enqueue and dequeue simultaneously. A producer core, for example, is a core of the multi-core processor that enqueues the event or packet to the flow queue on failing to acquire the flow lock. A consumer core is a core of the multi-core processor that successfully acquires the flow lock of the flow and sequentially processes the event or packet from the flow queue. The cores of the multi-core processor are not strictly segregated as the producer cores and the consumer cores, whereas the segregation is based on an ongoing work assigned to each core.

FIG. 1 illustrates a flow diagram (10) of an existing method of acquiring and releasing the critical section flow lock according to the related art.

At operation 11, the method includes dequeuing the packets from a generic queue and core dedicated queues. At operation 12, the method includes performing initial validation of the packets. At operation 13, the method includes determining whether the event with flow lock is needed. At operation 14, the method includes processing the event when determining that the flow lock is not needed, and continuing operation 11. At operation 15, the method includes determining whether the acquisition of the critical section flow lock is success or failure when determining that the flow lock is needed. At operation 16, the method includes enqueuing the event to the flow queue when the critical section flow lock acquisition is failure, and continuing operation 11. At operation 17, the method includes processing the new event when the critical section flow lock is success. At operation 18, the method includes, for example, determining whether the flow queue is empty. At operation 19, the method includes processing the event when the flow queue is not empty. At operation 20, the method includes releasing the critical section flow lock when the flow queue is empty.

In one scenario, the consumer core processes the event from the flow queue one by one until queue is empty. The consumer core cannot get the event dedicated to the consumer core during that time. The event dedicated or specific to the consumer core is called as a core dedicated or specific event such as a timer event. For example, when the timer event is triggered for a particular core, then the timer event has to be processed on same particular core as the timer event is attached to the particular core. The core dedicated or specific event remains unprocessed until the flow queue becomes empty. If the consumer core has to get the core specific event, then the consumer core has to stop processing the flow queue. The consumer core loses context of the flow and releases the critical section flow lock as the core specific events may belong to another flow.

In another scenario, the consumer core may get completely busy in processing the events or packets of the flow by dequeuing from the flow queue when packet enqueue rate to flow queue is very high leading to the higher core load of consumer core. The consumer core, for example, might have to stop processing the critical section of one flow and start processing the critical section of another flow to have load balancing across the flows or cores. There arises a problem if the consumer core stops processing the critical section of the flow, there should be a mechanism to process remaining events or packets in the flow queue of current processing flow. Consider a scenario where the consumer core stops processing the critical section of a flow and releases flow lock with still some pending events or packets in the flow queue. If a core receives a new event or packet for the same flow, if none of the core is processing the critical section of the flow, then the new packet may be processed followed by processing of pending events or packets in flow queue after acquiring the flow lock identified from the flow ID. If no new event or packet belonging to the same flow comes, then pending events or packets are not processed at all, which leads to buffer depletion.

Since, the multiple producer processor cores process the non-critical section in parallel, a volume of the packet coming to the flow queue will be very high compared to processing rate, which leads to scenario where the consumer core with the flow lock becomes busy leading to higher core-utilization or load compared to other producer cores causing uneven core load distribution.

It is desired to have mechanism to process the core dedicated or specific events with higher priority and evenly distribute the core load across multiple cores of the multi-core processor.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an electronic device for data packet flow distribution in a multi-core processor. The method provides better load balancing by distributing single flow critical section processing across multiple cores of the multi-core processor.

Another aspect of the disclosure is to efficiently handle core dedicated or specific event at a multi-core processor on priority while holding a critical section flow lock and processing packets from a flow queue, without losing context (i.e. information of packets pending to process) of the flow queue and ingress order of the packets in the flow queue.

Another aspect of the disclosure is to avoid using a core as a scheduler of the multi-core processor and make available all cores of the multi-core processor for data plane packet processing to get additional throughput gain.

Additional aspects will be set forth in part in the description which follows and, in part, will be apparent from the description, or may be learned by practice of the presented embodiments.

In accordance with an aspect of the disclosure, a method for data packet flow distribution in a multi-core processor by an electronic device is provided. The method includes receiving, by the electronic device, at least one data packet to be processed by the multi-core processor, determining, by the electronic device, whether a flow lock of a critical section of a data flow is acquired at a core of the multi-core processor, determining, by the electronic device, whether a threshold number of data packet from a flow queue is processed at the core upon successful flow lock acquisition, determining, by the electronic device, pending data packet to be processed in the flow queue upon processing the threshold number of data packet from the flow queue, creating, by the electronic device, a new trigger packet or event upon determining pending data packet to be processed in the flow queue, releasing, by the electronic device, the flow lock of the critical section, enqueuing, by the electronic device, the new trigger packet or event to a generic queue to be processed by other cores of the multi-core processor.

In an example embodiment, where the cores of the multi-core processor parallelly process the data packet of the data flow from the queue.

In an example embodiment, where the threshold number of data packets is configured based on a criticality of core dedicated or specific events and average per packet processing cycles.

In an example embodiment, where the new trigger packet or event is a buffer including a message type as trigger, where the message or the buffer including a flow identifier.

In an example embodiment, where determining, by the electronic device, that the threshold number of data packets from the flow queue is processed at the core, includes determining, by the electronic device, whether the received data packet is a new trigger packet or event, determining, by the electronic device, a flow from the new trigger packet or event upon determining that the received data packet is the new trigger packet or event, acquiring, by the electronic device, the flow lock, processing, by the electronic device, the new trigger packet or event upon successful flow lock acquisition, and dequeuing, by the electronic device, the data packets from the flow queue one by one till the threshold number of packets are processed or the flow queue is empty.

In an example embodiment, after the critical section lock acquisition, processing the threshold number of packets of the data flow from the flow queue includes determining, by the electronic device, whether the received data packet is a new event or packet or a trigger packet or event, determining, by the electronic device, whether the flow queue is empty or not upon determining that the received data packet is the new packet or event, enqueueing by the electronic device, the new packet or event to a tail end of the flow queue upon determining that the flow queue is not empty, and processing, by the electronic device, the data packets from the flow queue one by one till the threshold number of data packets are processed or the flow queue is empty.

In an example embodiment, where the method includes creating, by the electronic device, a new trigger event with a flow identifier after processing the threshold number of data packets upon determining that the flow queue is not empty. The method includes releasing, by the electronic device, flow lock. The method includes enqueuing, by the electronic device, the trigger event to the generic queue.

In an example embodiment, where the method includes dropping, by the electronic device, the new trigger packet or event upon failure to acquire the flow lock.

In an example embodiment, where the new trigger packet or event is a linked list of packets to be processed with a flow identifier.

In an example embodiment, where determining, by the electronic device, that the threshold number of data packets from the flow queue is processed at the core includes determining, by the electronic device, whether the received data packet is a new packet or event or a trigger packet or event, determining, by the electronic device, a data flow from the new trigger packet or event upon determining that the received data packet is the new trigger packet or event having a pending event or packet list, determining, by the electronic device, whether the flow lock may be acquired, performing, by the electronic device, enqueuing pending packet or events from the pending event or packet list to beginning of the flow queue upon failure to acquire the flow lock, or processing the new trigger packet or event and enqueue the events or packets in pending list to the beginning of flow queue and process one by one till the threshold number of data packets are processed or the flow queue is empty upon successful flow lock acquisition.

In an example embodiment, where the method includes creating, by the electronic device, a new trigger event with the pending packet or event list and a flow identifier after processing the threshold number of data packets upon determining that the flow queue is not empty. The method includes releasing, by the electronic device, flow lock. The method includes enqueuing, by the electronic device, the trigger event to the generic queue.

In an example embodiment, where determining, by the electronic device, that the threshold number of data packets from the flow queue is processed from the flow queue after flow lock acquisition at the core includes determining, by the electronic device, that the threshold number of data packets are processed, and dequeuing, by the electronic device, core-specific events or time-critical events from the generic queue or core dedicated queue.

In an example embodiment, where the method includes determining, by the electronic device, corresponding flow of the obtained events. The method includes enqueuing, by the electronic device, the obtained events to the generic queue upon determining that the obtained events belonging to a different flow. The method includes processing, by the electronic device, the obtained events, upon determining that the obtained events belonging to same flow.

In an example embodiment, where the method includes determining, by the electronic device, number of data packets in the flow queue. The method includes dequeuing, by the electronic device, the data packets from the flow queue until the flow queue is empty. The method includes processing, by the electronic device, the data packets.

In an example embodiment, where the all enqueues and dequeues to the flow queue are done after acquiring the flow queue lock.

In accordance with another aspect of the disclosure, an electronic device for the data packet flow distribution in at least one multi-core processor is provided. The electronic device includes memory, comprising one or more storage media, storing instructions, the at least one multi-core processor communicatively coupled to the memory, a flow processing controller, coupled to the memory and the at least one multi-core processor, wherein the instructions, when executed by the at least one multi-core processor individually or collectively, cause the electronic device to receive the data packet to be processed by the at least one multi-core processor, determine whether the flow lock of the critical section of the data flow is acquired at the core of the at least one multi-core processor, determine whether the threshold number of data packets from the flow queue is processed at the core upon successful flow lock acquisition, determine pending data packets to be processed in the flow queue upon processing the threshold number of data packets from the flow queue, create the new trigger packet or event upon determining the pending data packets to be processed in the flow queue, release the flow lock of the critical section, and enqueue the new trigger packet or event to the generic queue to be processed by other cores of the at least one multi-core processor.

In accordance with another aspect of the disclosure, one or more non-transitory computer readable memory storage media storing one or more computer programs including computer-executable instructions that, when executed by at least one processor of an electronic device individually or collectively, cause the electronic device to perform operations are provided. The operations include receiving data packets to be processed by a multi-core processor, determining whether a flow lock of a critical section of a data flow is acquired at a core of the multi-core processor, determining whether a threshold number of data packets from a flow queue are processed at the core upon successful flow lock acquisition, determining pending data packets to be processed in the flow queue upon processing the threshold number of data packets from the flow queue, creating a new trigger packet or event upon determining the pending data packets to be processed in the flow queue, releasing the flow lock of the critical section, and enqueueing the new trigger packet or event to a generic queue to be processed by other cores of the multi-core processor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flow diagram of an existing method of acquiring and releasing the critical section flow lock, according to the related art;

FIG. 2 is a block diagram of an electronic device for data packet flow distribution in a multi-core processor, according to an embodiment of the disclosure;

FIG. 3 illustrates a flow diagram of a method for the data packet flow distribution in the multi-core processor, according to an embodiment of the disclosure;

FIG. 4 illustrates a flow diagram of a method for the data packet flow distribution in the multi-core processor by creating a new trigger event, according to an embodiment of the disclosure;

FIGS. 5A, 5B, 5C, 5D, 5E, 5F, 5G, 5H, 5I, 5J, 5K, 5L, 5M, 5N, 5O, 5P, 5Q, 5R, 5S, 5T, and 5U are schematic diagrams illustrating an example scenario of the data packet flow distribution in the multi-core processor, according to various embodiments of the disclosure;

FIG. 6 illustrates a flow diagram of a method for the data packet flow distribution in the multi-core processor by creating a pending packet list, according to an embodiment of the disclosure;

FIG. 7 illustrates a flow diagram of a method for the data packet flow distribution in the multi-core processor by processing an intermediate core dedicated event, according to an embodiment of the disclosure; and

FIG. 8 illustrates examples for a trigger packet, a pending packet list, and a new flow specific event, according to an embodiment of the disclosure.

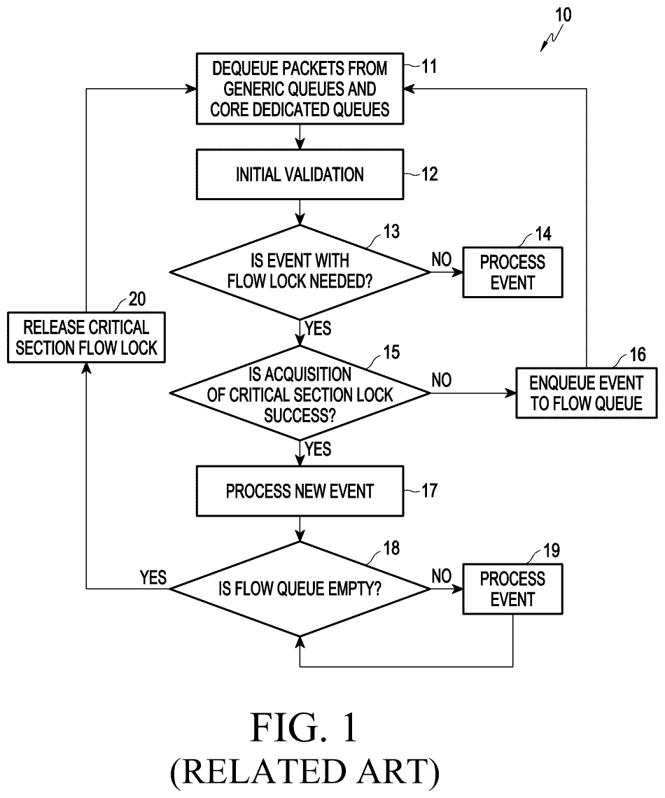

Throughout the drawings like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many, if not most instances, such definitions apply to prior as well as future uses of such defined words and phrases.

Embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. The disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “data packet”, “packet” “event” and “data” are used interchangeably and mean the same. Throughout this disclosure, the terms “flow lock” and “critical section flow lock” are used interchangeably and mean the same. Throughout this disclosure, the terms “flow” and “data flow” are used interchangeably and mean the same.

The embodiments herein provide a method for data packet flow distribution in a multi-core processor by an electronic device. The method includes receiving, by the electronic device, data packets to be processed by the multi-core processor. The method includes determining, by the electronic device, whether a flow lock of a critical section of a data flow may be acquired at a core of the multi-core processor. The method includes determining, by the electronic device, whether a threshold number of data packets from a flow queue is processed at the core upon successful flow lock acquisition. The method includes, for example, determining, by the electronic device, pending data packets to be processed in the flow queue upon processing the threshold number of data packets from the flow queue. The method includes creating, by the electronic device, a new trigger packet or event with a flow identifier upon determining pending data packets to be processed in the flow queue. The method includes releasing, by the electronic device, the critical section flow lock. The method includes enqueuing, by the electronic device, the new trigger packet or event to a generic queue to be processed by other cores of the multi-core processor.

The embodiments herein provide the electronic device for the data packet flow distribution in the multi-core processor. The electronic device includes a flow processing controller, memory, the multi-core processor, where the flow processing controller is coupled to the memory and the multi-core processor. The flow processing controller is configured for receiving the data packet to be processed by the multi-core processor. The flow processing controller is configured for determining whether the flow lock of the critical section of the data flow may be acquired at the core of the multi-core processor. The flow processing controller is configured for determining whether the threshold number of data packets from the flow queue is processed at the core upon successful flow lock acquisition. In addition, the flow processing controller is configured for determining pending data packets to be processed in the flow queue upon processing the threshold number of data packets from the flow queue. The flow processing controller is configured for creating the new trigger packet or event with a flow identifier upon determining the pending data packets to be processed in the flow queue. The flow processing controller is configured for releasing the critical section flow lock. The flow processing controller is configured for enqueuing the new trigger packet or event to the generic queue to be processed by other cores of the multi-core processor.

In an embodiment, an efficient packet flow distribution method is proposed in this disclosure to terminate processing of one flow and process remaining packets or events of that flow using the other cores of the multi-core processor by creating a new trigger event or a pending packet list with a flow identifier and by sending the new trigger event or the pending packet list as a new event to be processed by the other cores. Core of the muti-core processor holding the critical section lock of the flow, stops processing the packets of that flow after processing threshold number (e.g. 200) of packets or events and checks for the core specific event or other flow events for proper load balancing.

In an embodiment of a method of the packet flow distribution, the multiple cores work on the packets from a flow in parallel. During sequential section of the packet processing by one of the core which holds the critical section flow lock, the flow processing controller creates the new trigger packet including a flow identifier and enqueues to the generic ring or queue after processing the threshold number of packets from the flow queue. The enqueued new trigger packet may be further dequeued and processed by the other cores after acquiring the critical section flow lock and in turn continue processing packets from the flow queue. In case of any failure in acquiring the flow lock by the flow processing controller trigger packet is freed by the core.

In another example embodiment of the method of the packet flow distribution, the multiple cores work on the packets from the flow in parallel. During the sequential section of the packet processing by one of the core which holds the critical section flow lock, the flow processing controller creates a list of pending packets to be processed in the flow queue together with the flow identifier called a pending list as a trigger event and enqueues to the general ring or queue after processing the threshold number of packets from the flow queue. Any core may dequeue the new pending list from the general ring or queue and process the new pending list. Upon failure in acquiring the flow lock, the core, for example, enqueues the pending packet or events from the pending event or packet list to beginning of the flow queue to preserve ordered processing. Upon successful flow lock acquisition, the core processes the new trigger packet or event, enqueues the events or packets in the pending list to the beginning of flow queue and processes the events or packets one by one.

According to an example embodiment of the method of the packet flow distribution, the multiple cores work on the packets from a flow in parallel. During the sequential section of the packet processing by one of the core which holds the critical section flow lock, and after processing the threshold number of packets from the flow queue, the flow processing controller checks for a core dedicated event on the core, and processes core dedicated event if the core dedicated event belong to same flow as of the acquired critical section flow lock. If the core dedicated event belongs to a different flow, then the flow processing controller creates a new event containing the core dedicated event with a flow identifier, and enqueues to the general ring or queue which may dequeued and processed by the other cores.

The method is useful in a scenario where one core of the multi-core processor holds the flow lock, keeps continuously processing the packets from the flow specific queue and cannot handle the pending core dedicated event. For example, the flow processing controller preserves context (i.e. order or sequence) of the pending packets of the flow queue by creating a trigger event or a pending packet list and enqueuing the trigger event or the pending packet list to the queue. Trigger event or a pending packet list include a flow identifier in it. Upon dequeuing the trigger event or the pending packet list, the core gets the context of the flow, acquires the flow lock and proceed processing the critical section. The proposed method minimizes packet reordering in scenarios by first processing the pending packet or event list and then process new packets.

Unlike existing methods and systems, the flow processing controller is essential to support the core-pool deployment in environments without using software or hardware schedulers, where cores dequeue packets from queues or rings and use the multiple cores of the multi-core processor for high per flow throughput and provide efficient load-balancing and help in power saving scheme deployments.

The flow processing controller never chooses a core of the multi-core processor for software event scheduling. So that, all cores will be available for data plane packet processing to get additional throughput gain. The flow processing controller supports timely handling of the core dedicated event and provides efficient load-distribution across the multiple cores and also helps in deploying load-balancing based power saving schemes without damaging ordered packet processing.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

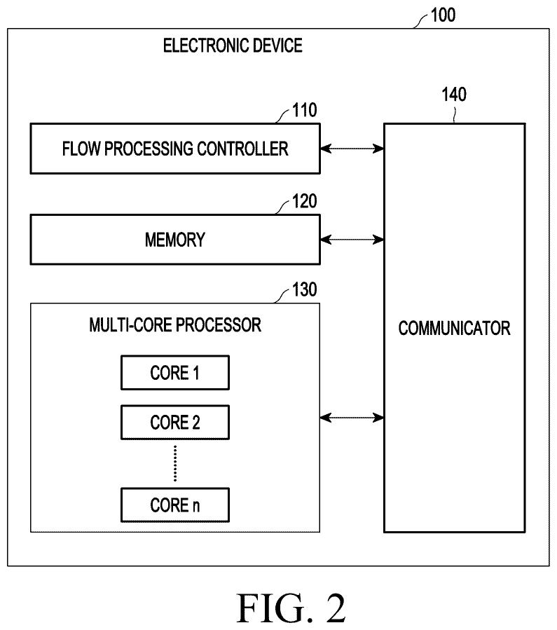

FIGS. 2 to 4, 5A to 5U, and 6 to 8, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

FIG. 2 is a block diagram of an electronic device (100) for data packet flow distribution in a multi-core processor (130), according to an embodiment of the disclosure.

Examples of the electronic device (100) include, but are not limited to a smartphone, a tablet computer, a personal digital assistance (PDA), a desktop computer, an internet of things (IoT), a wearable device, etc. In an embodiment, the electronic device (100) includes a flow processing controller (110), memory (120), the multi-core processor (130), and a communicator (140), where the flow processing controller (110) is coupled to the memory (120) and the multi-core processor (130) via the communicator (140). In another embodiment, the electronic device (100) includes memory (120), the multi-core processor (130), and a communicator (140), where each core (e.g. core 1 to core n) of the (e.g. core 1 to core n) includes the flow processing controller (110). The flow processing controller (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The memory (120) contains all types of queues. The memory (120) stores, for example, instructions to be executed by the multi-core processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) may be configured to store larger amounts of information than its storage space. In various examples, a non-transitory storage medium may store data that may, over time, change (e.g., in random access memory (RAM) or cache). The memory (120) may be an internal storage unit or it may be an external storage unit of the electronic device (100), a cloud storage, or any other type of external storage.

The multi-core processor (130) is configured to execute instructions stored in the memory (120). The multi-core processor (130) may be a general-purpose processor, such as a central processing unit (CPU), an application multi-core processor (AP), or the like, a graphics-only processing unit such as a graphics processing unit (GPU), a visual processing unit (VPU) and the like. The multi-core processor (130) includes, for example, multiple cores (e.g. core 1 to core n) to execute the instructions. In an embodiment, the multiple cores of the multi-core processor (130) parallelly process the data packet of the data flow from a flow queue.

The communicator (140) is configured for communicating internally between hardware components in the electronic device (100). Further, the communicator (140) is configured to facilitate the communication between the electronic device (100) and other devices via one or more networks (e.g. radio technology). The communicator (140) includes an electronic circuit specific to a standard that enables wired or wireless communication.

In an embodiment, the flow processing controller (110) receives a data packet of a flow to be processed by the multi-core processor (130). Further, the flow processing controller (110) attempts to acquire a flow lock of a critical section of a data flow at a core of the multi-core processor (130). Further, the flow processing controller (110) determines that a threshold number of data packets from the flow queue is processed at the core upon successful flow lock acquisition. In an embodiment, the threshold number of data packets is configured based on a criticality of core specific events and average per packet processing cycles. In an embodiment, the new trigger packet or event is a buffer including a message type as trigger, where the message or the buffer including a flow identifier.

The flow processing controller (110) determines whether the received data packet is a new event or packet or a trigger packet or event. Further, the flow processing controller (110) determines whether the flow queue is empty or not upon determining that the received data packet is the new packet or event. Further, the flow processing controller (110) enqueues the new packet or event to a tail end of the flow queue upon determining that the flow queue is not empty. Further, the flow processing controller (110) processes the data packets from the flow queue one by one till the threshold number of data packets are processed. The flow processing controller (110) determines, for example, pending data packets to be processed in the flow queue. Further, the flow processing controller (110) creates a new trigger packet or event with a flow identifier upon determining pending data packets in the flow queue. Further, the flow processing controller (110) releases the critical section flow lock. The flow processing controller (110) enqueues the new trigger packet or event to a generic queue to be processed by other cores of the multi-core processor (130).

Upon determining that received data packet is trigger event, the flow processing controller (110) drops the new trigger packet or event upon failure to acquire the flow lock. Flow processing controller (110) processes the new trigger packet or event upon successful flow lock acquisition. Further, the flow processing controller (110) dequeues the data packets from the flow queue one by one till the threshold number of packets are processed. Further, the flow processing controller (110) releases the flow lock upon processing the packets.

In another embodiment, the new trigger packet or event is a linked list of packets to be processed with a flow identifier. For determining that the threshold number of data packets from the flow queue is processed at the core, the flow processing controller (110) determines whether the received data packet is the new packet or event or the trigger packet or event. The flow processing controller (110) determines the data flow from the new trigger packet or event upon determining that the received data packet is the new trigger packet or event having a pending event or packet list. Further, the flow processing controller (110) determines whether the flow lock may be acquired. Further, the flow processing controller (110) enqueues pending packet or events from the pending event or packet list to beginning of the flow queue upon failure to acquire the flow lock. Further, the flow processing controller (110) processes the new trigger packet or event, enqueues the events or packets in the pending list to the flow queue, and processes one by one until threshold number of events are processed or flow queue is empty upon successful flow lock acquisition. The flow processing controller (110) determines, for example, pending data packets to be processed in the flow queue. Further, the flow processing controller (110) creates a new trigger packet or event pending list with the flow identifier upon determining pending data packets in the flow queue. Further, the flow processing controller (110) releases the critical section flow lock. The flow processing controller (110) enqueues the new trigger packet or event to a generic queue to be processed by other cores of the multi-core processor (130).

In yet another embodiment, for determining that the threshold number of data packets from the flow queue is processed from the flow queue after flow lock acquisition at the core, the flow processing controller (110) determines that the threshold number of data packets are processed. Further, the flow processing controller (110) dequeues core-specific events or time-critical events (i.e. obtained events) from the generic queue. The flow processing controller (110) determines corresponding flow of the obtained events. The flow processing controller (110) enqueues the obtained events to the generic queue upon determining that the obtained events belonging to a different flow. The flow processing controller (110) processes the obtained events, upon determining that the obtained events belonging to same flow, and operation of dequeuing core specific events is continued until all the core specific events are processed and the process is continued until the flow queue is empty.

The flow processing controller (110) determines number of data packets in the flow queue. Further, the flow processing controller (110) dequeues the data packets from the flow queue and process packets until the flow queue is empty.

In the above embodiments the flow processing controller (110) enqueues and dequeues the data packets to the flow queue after acquiring the flow queue lock.

Although FIG. 2 shows the hardware components of the electronic device (100) but it is to be understood that other embodiments are not limited thereon. In other embodiments, the electronic device (100) may include less or a greater number of components. Further, the labels or names of the components are used only for illustrative purpose and does not limit the scope of the disclosure. One or more components may be combined together to perform same or substantially similar function for the data packet flow distribution in the multi-core processor (130).

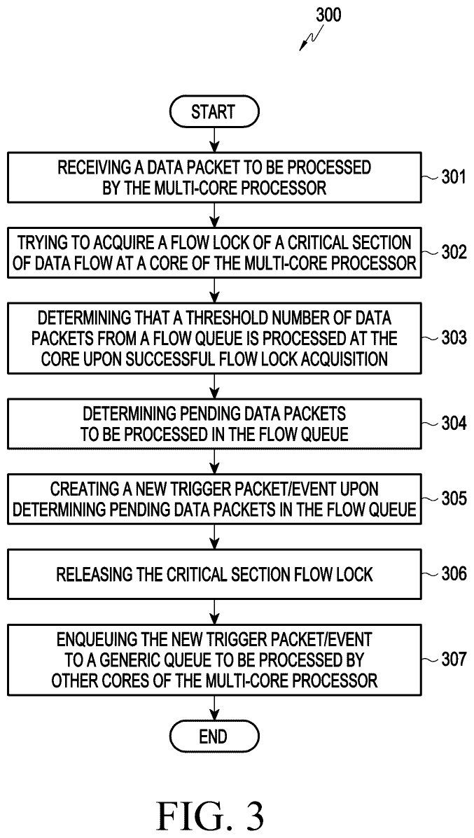

FIG. 3 illustrates a flow diagram of a method for the data packet flow distribution in the multi-core processor (130), according to an embodiment of the disclosure. In an example embodiment, the method allows the flow processing controller (110) to perform operation 301-307 of the flow diagram (300).

At operation 301, the method includes receiving the data packet to be processed by the multi-core processor (130). At operation 302, the method includes attempting to acquire the flow lock of the critical section of the data flow at the core of the multi-core processor (130). At operation 303, the method includes determining that the threshold number of data packets from the flow queue is processed at the core upon successful flow lock acquisition. At operation 304, the method includes determining the pending data packets to be processed in the flow queue. At operation 305, the method includes creating the new trigger packet or event upon determining the pending data packets in the flow queue. At operation 306, the method includes releasing the critical section flow lock. At operation 307, the method includes enqueuing the new trigger packet or event to the generic queue to be processed by other cores of the multi-core processor (130).

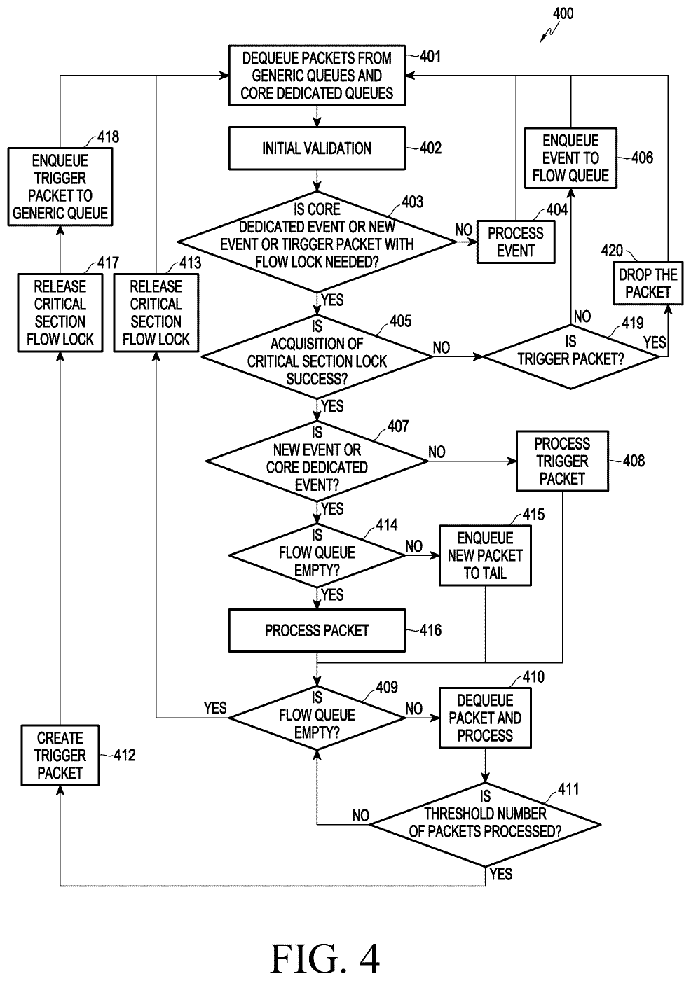

FIG. 4 illustrates a flow diagram (400) of a method for the data packet flow distribution in the multi-core processor (130) by creating the new trigger event, according to an embodiment of the disclosure.

At operation 401, the flow processing controller (110) dequeues and receives the packets from the generic queue and core dedicated queues. At operation 402, the flow processing controller (110) performs initial validation of the packets by identifying to which flow the packet belongs to. At operation 403, the flow processing controller (110) determines whether the received packet is the core dedicated event or the new event or the trigger packet with flow lock needed. At operation 404, the flow processing controller (110) configures the core to process the received packet when the received packet is not the core dedicated event or the new event or the trigger packet with flow lock requirement, and continues to perform 401.

At operation 405, the flow processing controller (110) determines whether the acquisition of the critical section flow lock by the core is success or failure when determining that the flow lock is needed. At operation 419, the flow processing controller (110) checks for the trigger packet, when the acquisition of the critical section lock is failure. At operation 406, the flow processing controller (110) enqueues packet to the flow queue if the packet is not the trigger packet and continues to perform 401. At operation 420, the flow processing controller (110) drops the packet if the packet is the trigger packet as other core has started processing this flow by acquiring lock, and continues to perform 401. At operation 407, the flow processing controller (110) determines whether the received packet is the new event or the core dedicated event.

At operation 408, the flow processing controller (110) processes the trigger packet when the received packet is not the new event or the core dedicated event and performs operation 409. The flow processing controller (110) identifies the flow to which the trigger packet belongs to. At operation 409, the flow processing controller (110) checks whether the flow queue is empty. Further, at operation 413, the flow processing controller (110) releases the critical section flow lock when the flow queue is empty.

At operations 410 and 411, if the flow queue is not empty, the flow processing controller (110) dequeues the packet and configures the core to process the packets from flow queue one by one until empty or threshold number of packet processed is hit. At operation 412, the flow processing controller (110) creates the trigger packet. Further at operation 417, the flow processing controller (110) releases the critical section lock. At operation 418, the flow processing controller (110) enqueue trigger packet to the generic queue.

At operation 414, the flow processing controller (110) determines whether the flow queue is empty when the received packet is the new event or the core dedicated event. At operation 415, the flow processing controller (110) enqueues the new packet to the tail end of the flow queue when the flow queue is not empty, and continues to perform 409. At operation 416, the flow processing controller (110) processes the event, when the flow queue is empty, and continues to perform 409.

In an example embodiment, after receiving the packet, the core checks whether the received packet is a trigger packet or not. The trigger event is the buffer consisting of the message type as trigger, where the buffer consists of the flow ID. The flow processing controller (110) uses a parameter (e.g. a call ID, a radio bearer (RB) ID, a cell number) in the packet to derive the flow ID. The threshold number of packets are configured based on the criticality of core specific events and the average per packet processing cycles. Example if events are of type timer and timer is of 10 ms duration, and +/−0.01 milliseconds processing is not going to impact significantly. If average processing cycles per packet is 2000 and system is 2 gigahertz then we may keep a threshold of 100.

After receiving the non-trigger packet of the flow by the core, and if the critical section flow lock may be acquired, then the core checks for the flow queue to find the pending packets for processing belonging to same flow ID. On finding presence of the pending packets for processing, the flow processing controller (110) enqueues the non-trigger packet to tail of flow queue.

In an embodiment, after receiving trigger packet by the core, the flow processing controller (110) checks for the critical section flow lock. In an embodiment, if the critical section flow lock is failed to acquire, then trigger packet may be dropped.

In another embodiment, if the critical section flow lock is failed to acquire, then the flow processing controller (110) enqueues the pending packets in the pending list trigger event to the beginning of flow queue.

In an example embodiment, the flow processing controller (110) keeps processing the flow queue and checks for time critical events from the generic queue(s).

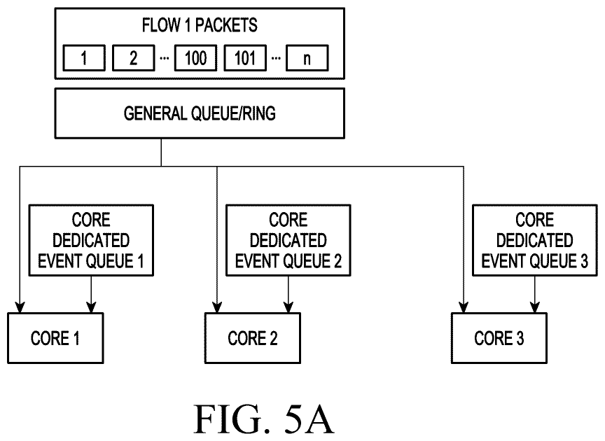

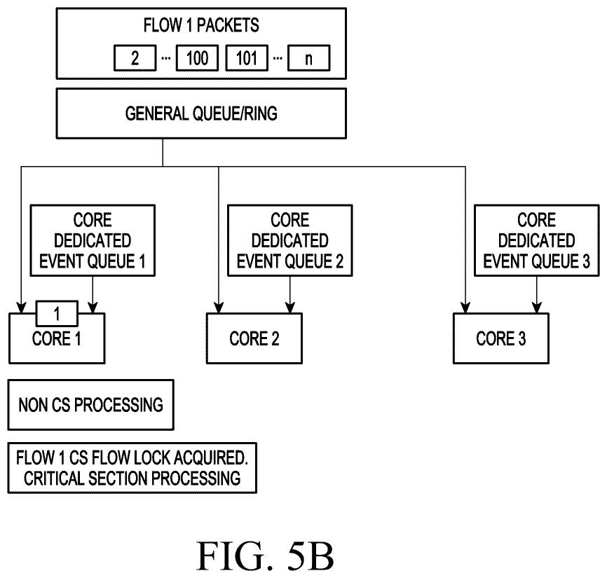

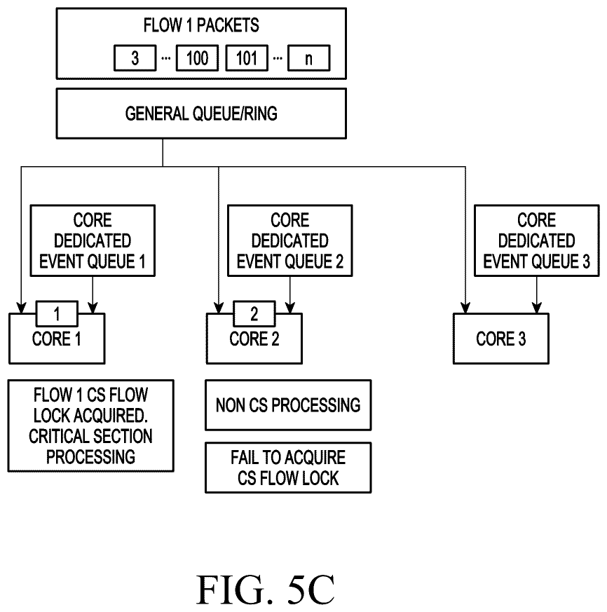

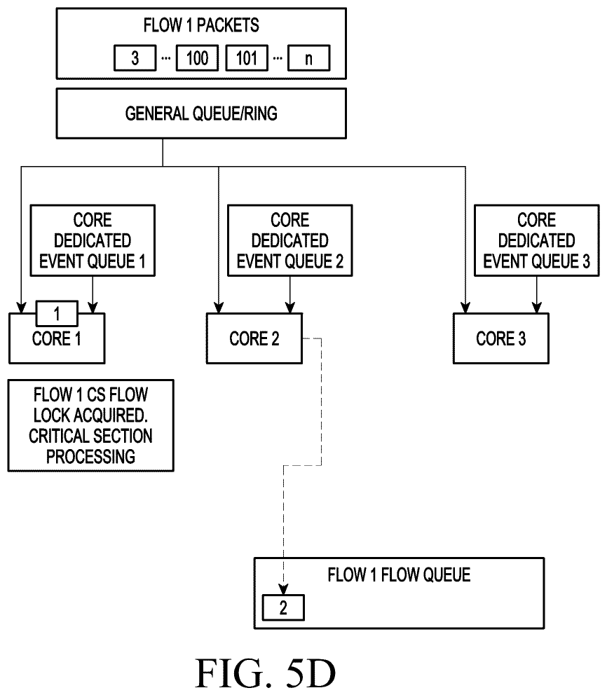

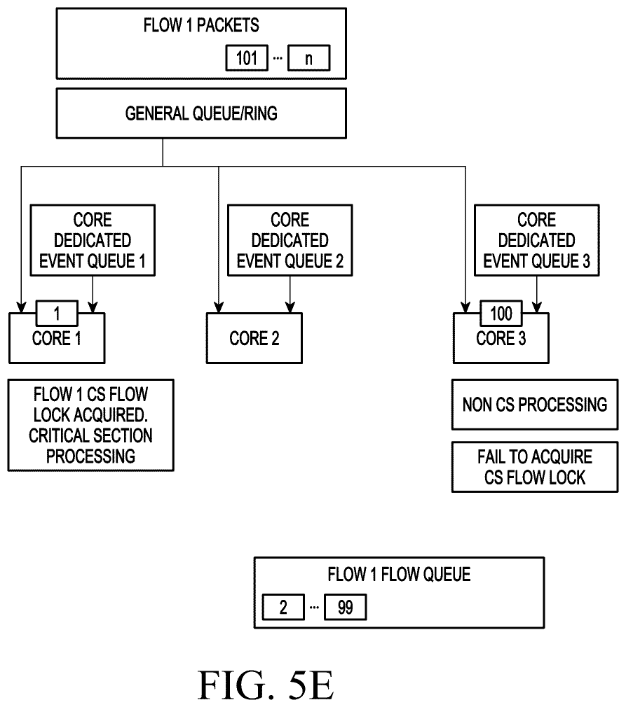

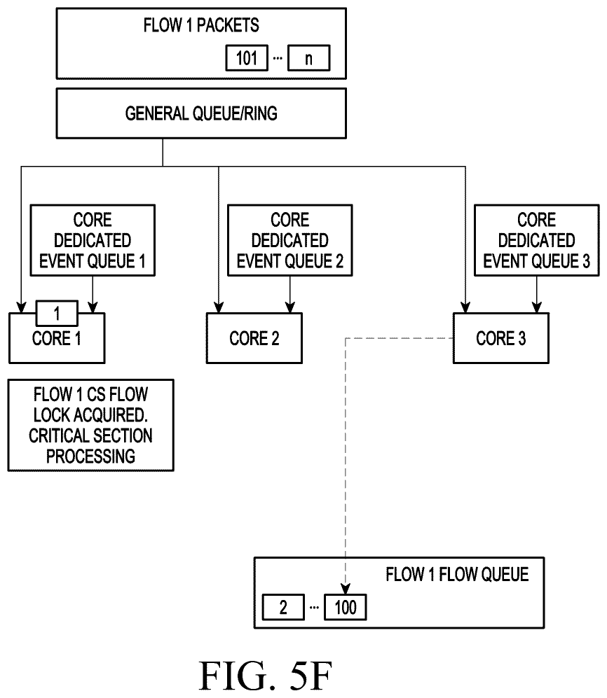

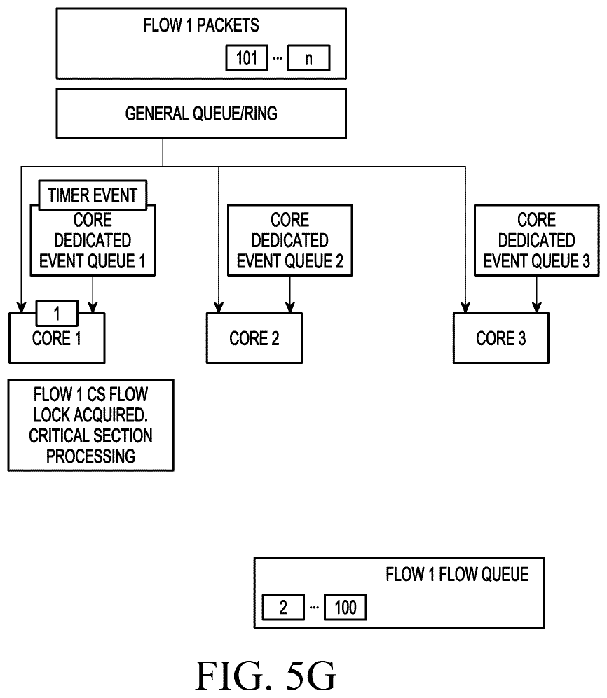

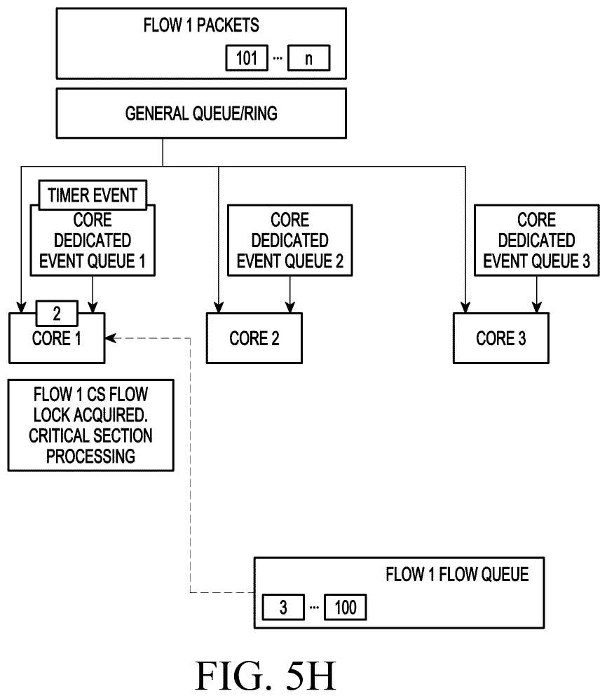

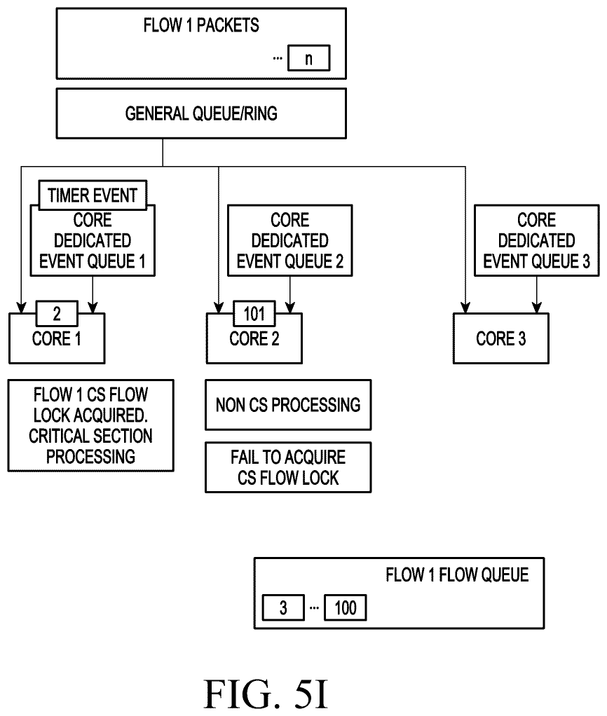

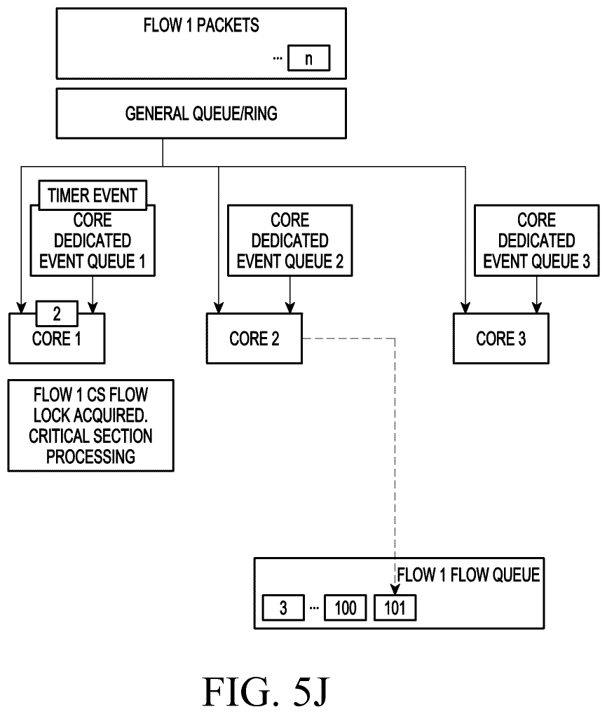

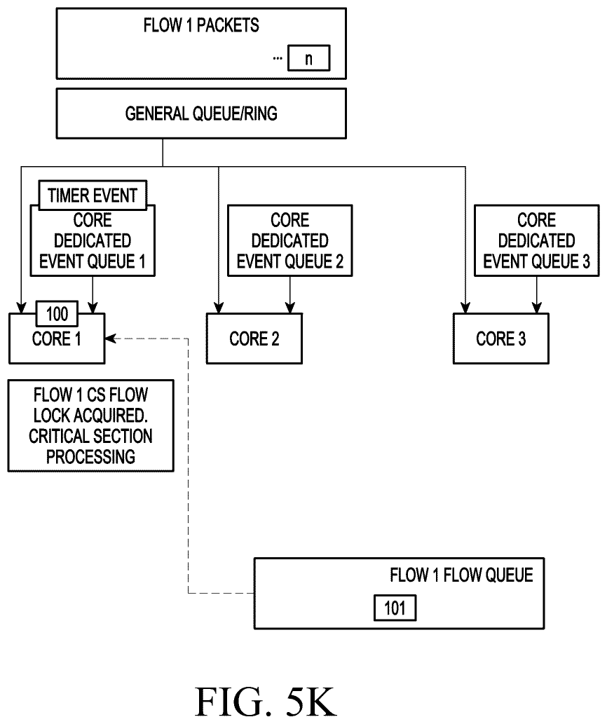

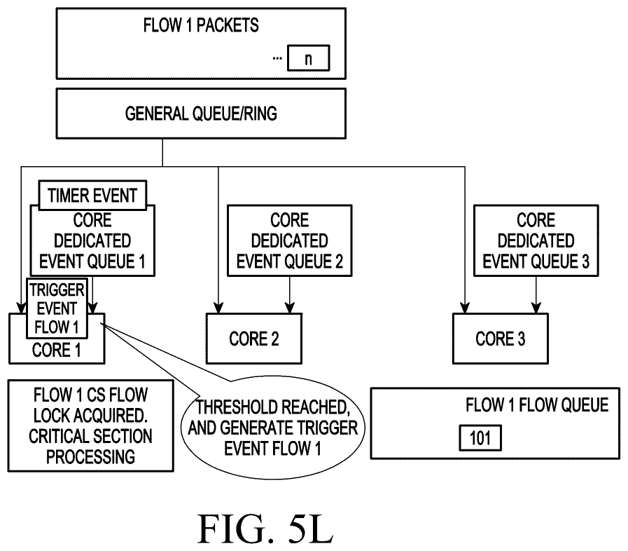

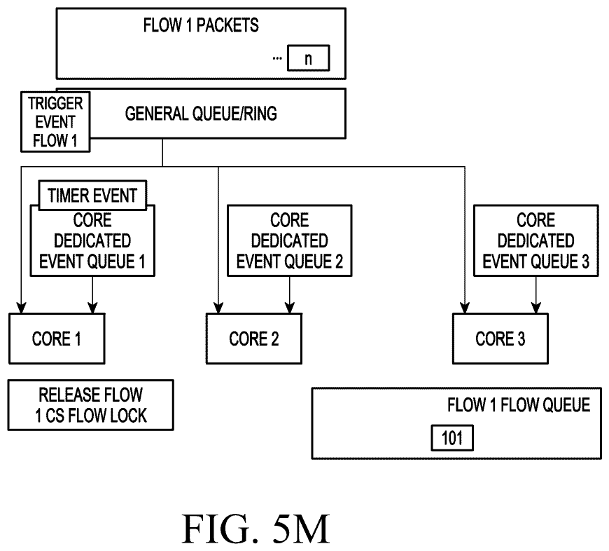

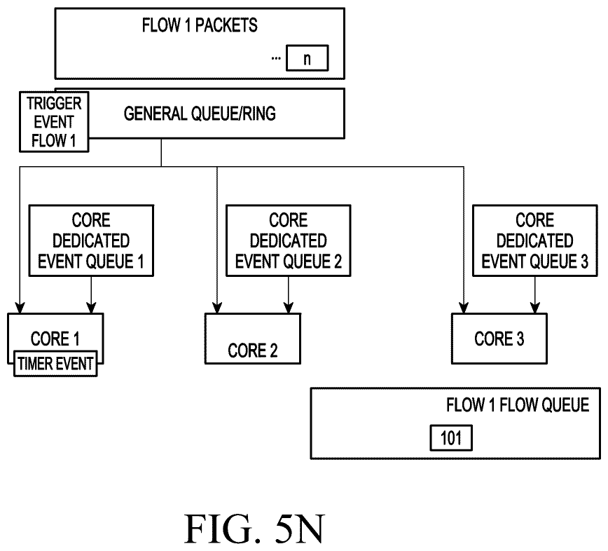

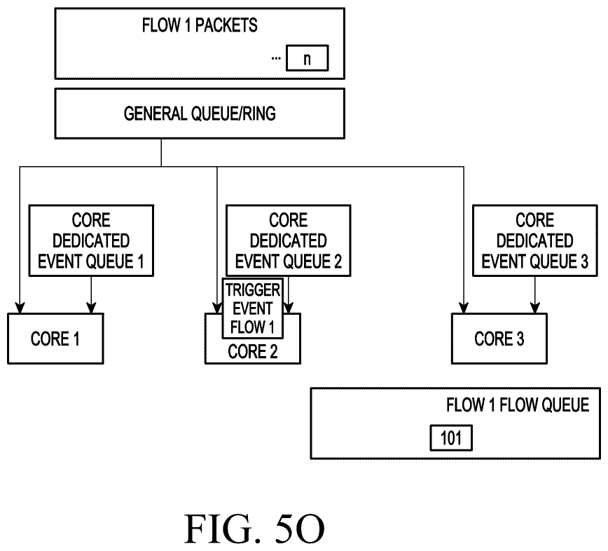

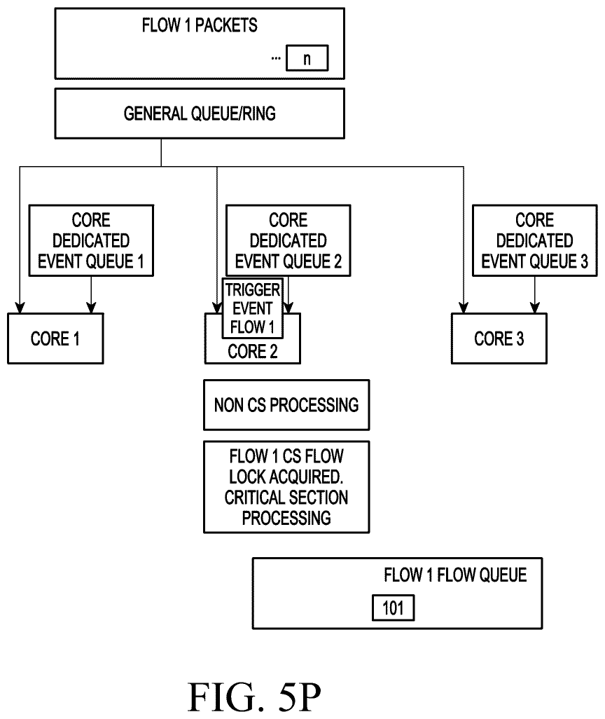

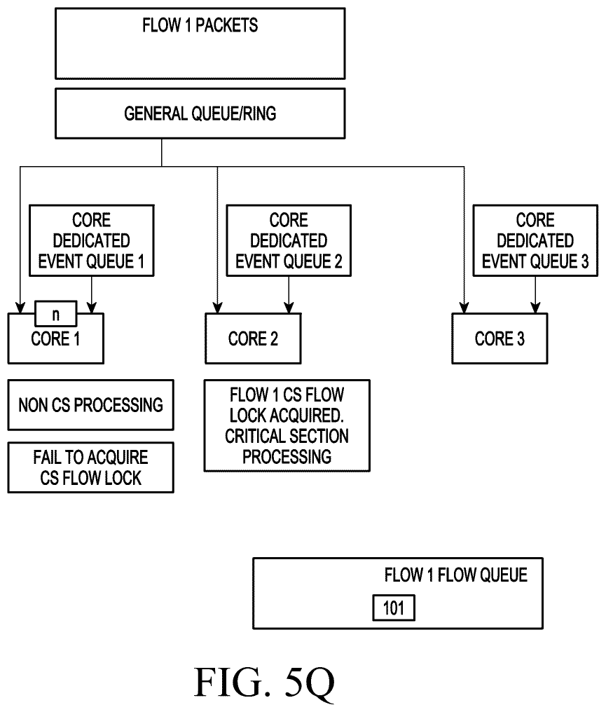

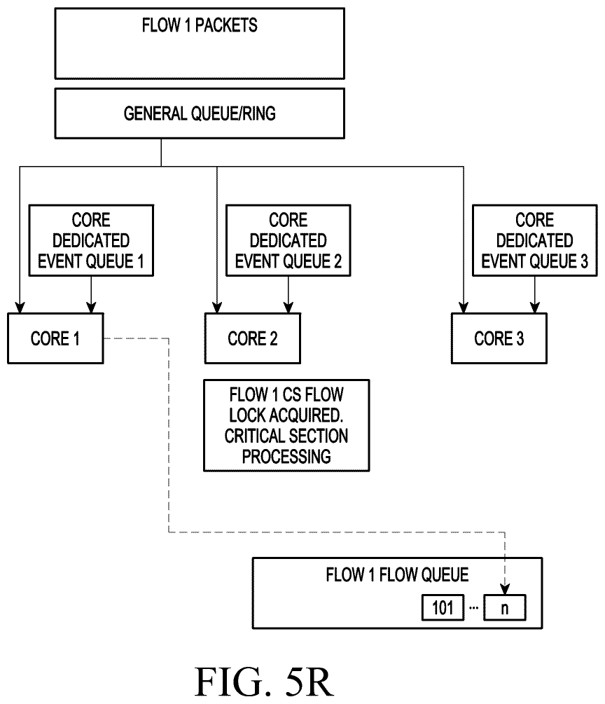

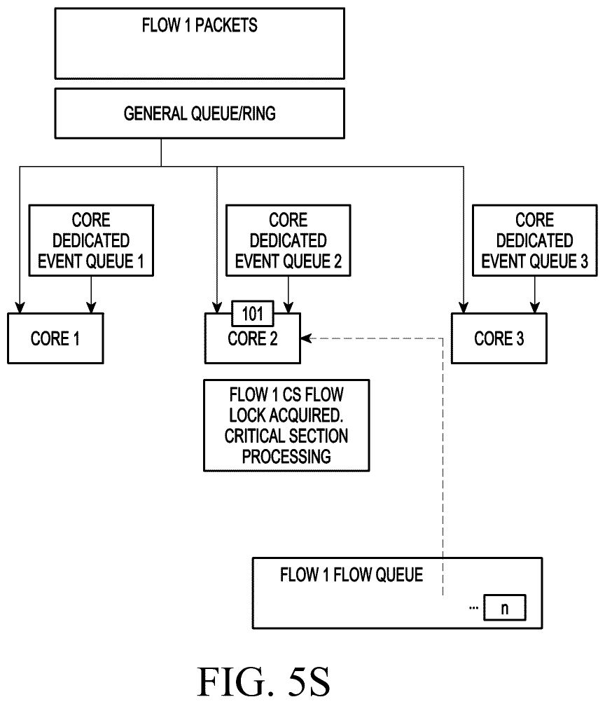

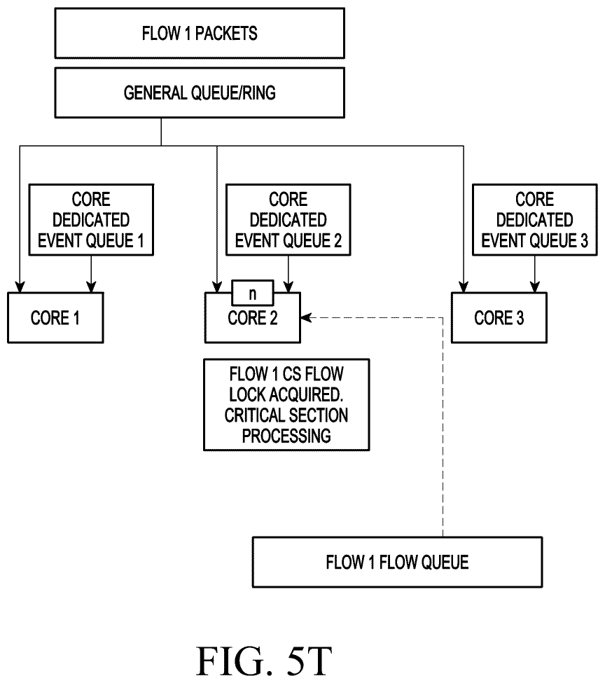

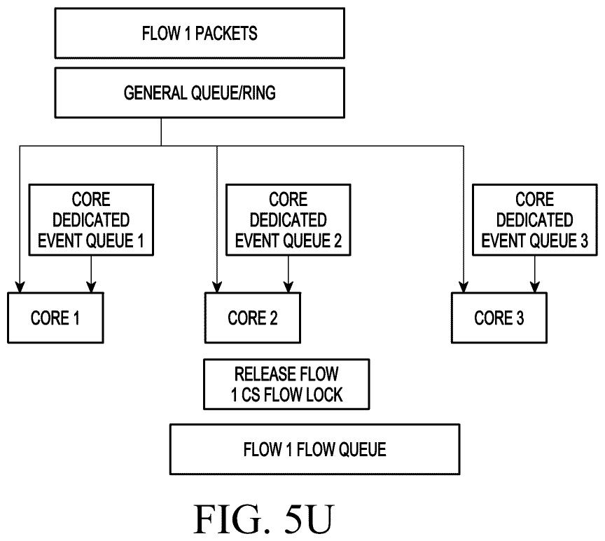

FIGS. 5A to 5U are schematic diagrams illustrating an example scenario of the data packet flow distribution in the multi-core processor (130), according to various embodiments of the disclosure.

Referring to the FIG. 5A, consider the example scenario in which, the multi-core processor (130) includes 3 cores: core 1, core 2, and core 3. The general queue or ring configured to parallelly provide packets in a flow 1 to each core, and a core dedicated event queue of each core is configured to provide the core dedicated events to corresponding core. The flow 1 includes “n” number of packets. Consider the threshold number of packets is configured as 100. Referring to FIG. 5B, the core 1 receives the packet 1 from the general queue or ring, and processes a non-critical section (non-CS) of the packet 1. Further, the core 1 detects the CS of the packet 1, acquires the flow lock, and starts processing the CS.

Referring to FIG. 5C, the core 2 receives the packet 2 from the general queue or ring, and processes the non-CS of the packet 2. Further, the core 2 detects the CS of the packet 2, fails to acquire the flow lock as the flow lock is already acquired by the core 1. Referring to FIG. 5D, upon failure in acquiring the flow lock, the core 2 enqueues packet 2 to the flow queue of the flow 1 (flow 1 flow queue). Similarly, the packets 3 to 99 are processed similarly to the packet 2, and enqueued in the flow 1 flow queue. Referring to FIG. 5E, the core 3 receives the packet 100 from the general queue or ring, and processes the non-CS of the packet 100. Further, the core 3 detects the CS of the packet 100, fails to acquire the flow lock as the flow lock is already acquired by the core 1. Referring to FIG. 5F, upon failure in acquiring the flow lock, the core 3 enqueues the flow queue of the flow 1 (i.e. flow 1 flow queue) with the packet 100. Referring to FIG. 5G, core dedicated event queue 1 receives a timer event for core 1, where the timer event is the core dedicated event generated at the core dedicated event queue 1 and unprocessed at the core 1. Referring to FIG. 5H, the core 1 holds processing of the timer event due to processing the CS of flow 1. The core 1 process the packet 2.

Referring to FIG. 5I, the core 2 receives the packet 101 from the general queue or ring, and processes the non-CS of the packet 101. Further, the core 2 detects the CS of the packet 101, fails to acquire the flow lock as the flow lock is already acquired by the core 1. Referring to FIG. 5J, upon failure in acquiring the flow lock, the core 2 enqueues the flow queue of the flow 1 (i.e. flow 1 flow queue) with the packet 101. Referring to FIG. 5K, the core 1 does not process timer event till it process the threshold number of packets, i.e. 100 packets. Referring to FIG. 5L, upon processing the packet 100 (i.e. threshold number of packets), the core 1 creates a trigger event for flow 1 called as a trigger event flow 1 and suspends processing the CS of remaining packets in flow queue. Referring to FIG. 5M, upon processing the threshold number of packets, the core 1 releases the flow lock, and sends the trigger event flow 1 to the general queue or ring to save the context of the flow 1 packets.

Referring to FIG. 5N, the core 1 process the timer event. As shown in FIG. 5O, the general queue or ring provides the trigger event flow 1 to the core 2. Referring to FIG. 5P, the core 2 receives the trigger event flow 1 from the general queue or ring, and processes the non-CS of the trigger event flow 1. Further, the core 2 identifies the packet (i.e. packet 101) from which the CS processing need to resume based on the trigger event flow 1 processing, acquires the flow lock, and starts processing the CS of packets in flow queue. Referring to FIG. 5Q, the core 1 receives the packet n from the general queue or ring, and processes the non-CS of the packet n. Further, the core 1 detects the CS of the packet n, fails to acquire the flow lock as the flow lock is already acquired by the core 2.

Referring to FIG. 5R, upon failure in acquiring the flow lock, the core 1 enqueues the flow queue of the flow 1 (flow 1 flow queue) with the packet n. Referring to FIG. 5S, the core 2 receives the packet 101 from the flow 1 flow queue, and processes the CS in the packet 101. Referring to FIG. 5T, the core 2 continues to process the CS of the packets from the flow 1 flow queue till the threshold number of packets or emptying the flow 1 flow queue, and processes the CS in the received packets. Referring to FIG. 5U, the core 2 releases the CS flow lock upon processing the CS of all packets in the flow 1 flow queue.

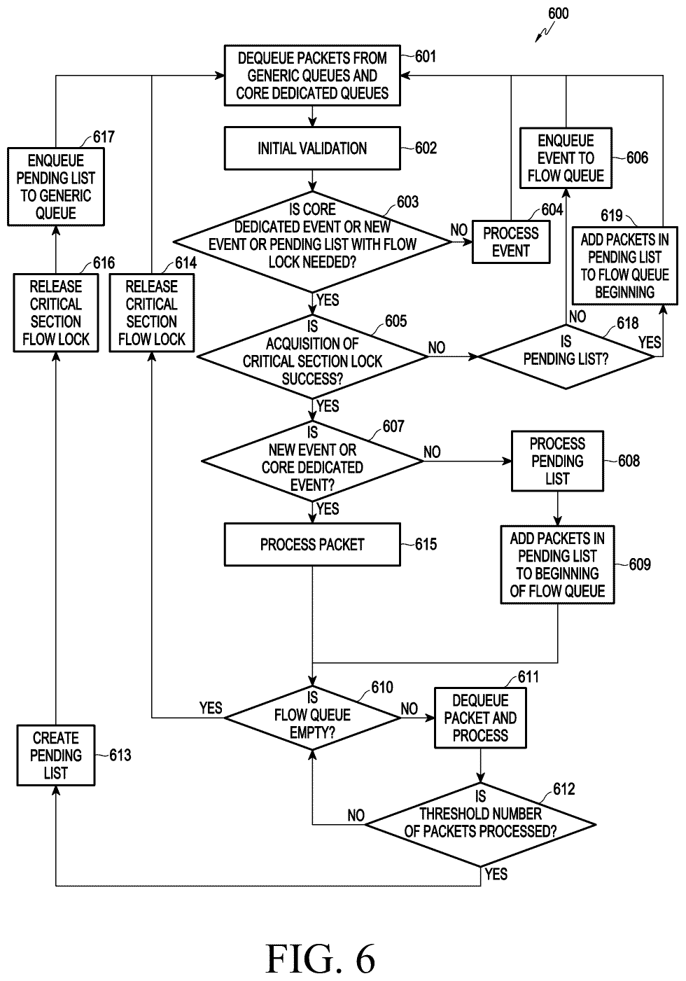

FIG. 6 illustrates a flow diagram (600) of a method for the data packet flow distribution in the multi-core processor (130) by creating a pending packet list, according to an embodiment of the disclosure.

At operation 601, the flow processing controller (110) dequeues and receives the packets from the generic queue and the core dedicated queues. At operation 602, the flow processing controller (110) performs the initial validation of the packets by identifying to which flow the packet belongs to. At operation 603, the flow processing controller (110) determines whether the received packet is the core dedicated event or the new event or the pending list with flow lock needed. At operation 604, the flow processing controller (110) configures the core to processes the received packet when the received packet is not the core dedicated event or the new event or the pending list with flow lock requirement, and continues to perform 601. At operation 605, the flow processing controller (110) determines whether the acquisition of the critical section flow lock by the core is success or failure when determining that the flow lock is needed. At operation 618, the flow processing controller (110) checks for the pending list, when the acquisition of the critical section lock is failure.

At operation 606, the flow processing controller (110) enqueues the packet or events to the flow queue when packet is not pending list, and continues to perform 601. At operation 619, the flow processing controller (110) adds the packets in the pending list to the flow queue beginning when is packet is pending list, and continues to perform 601. At operation 607, the flow processing controller (110) determines whether the received packet is the new event or the core dedicated event. At operation 608, the flow processing controller (110) processes the pending list when the received packet is not the new event or the core dedicated event. At operation 609, the flow processing controller (110) identifies the flow to which the pending list packet belongs to, and adds the packets in the pending list to the beginning of the flow queue for maintaining the packet order. Further, the flow processing controller (110) performs operation 615, if when the received packet is not pending list. At operation 615, if the packet is the dedicated core event or new packet or non-pending list packet, then the flow processing controller (110) processes the critical section of the received packet, and continues dequeuing from the flow queue one by one until empty or threshold number of packet processed is hit. At operations 610, 611, and 612, the flow processing controller (110) processes the packets from the flow queue one by one until empty or threshold number of packet processed is hit.

At operation 610, the flow processing controller (110) checks whether the flow queue is empty. At operation 614, the flow processing controller (110) releases the critical section flow lock when the flow queue is empty. At operation 613, the flow processing controller (110) creates the list of packets when flow queue is not empty. At operation 616, the flow processing controller (110) releases the critical section flow lock. Further at operation 617, the flow processing controller (110) enqueues the pending list to the generic queue.

The pending list event is the buffer consisting of the message type as the pending list. The buffer consists of the flow ID and the list of pending events or packets. The threshold number of packets is configured based on the criticality of core specific events and the average per packet processing cycles. For example, if the events are of type timer and the timer is of 10 milliseconds duration, and +/−0.01 millisecond processing is not going to impact significantly. If average processing cycles per packet is 2000 and system is 2 gigahertz then the threshold number of packets may keep as 100. After receiving the packet, the core checks whether the packet is the list of pending events or not.

After receiving the list of pending events, the core gets corresponding flow ID, and checks for the critical section flow lock. If critical section flow lock is available, the flow processing controller (110) adds the packets in the pending list to beginning of the flow queue of corresponding flow ID and processes the packets one by one.

After receiving the list of pending events, the core checks for the critical section flow lock. If the critical section flow lock is not available, then the flow processing controller (110) enqueues the pending list of packets to the beginning of the flow queue of corresponding flow ID to be taken up for processing immediate next by the core holding the critical section flow lock.

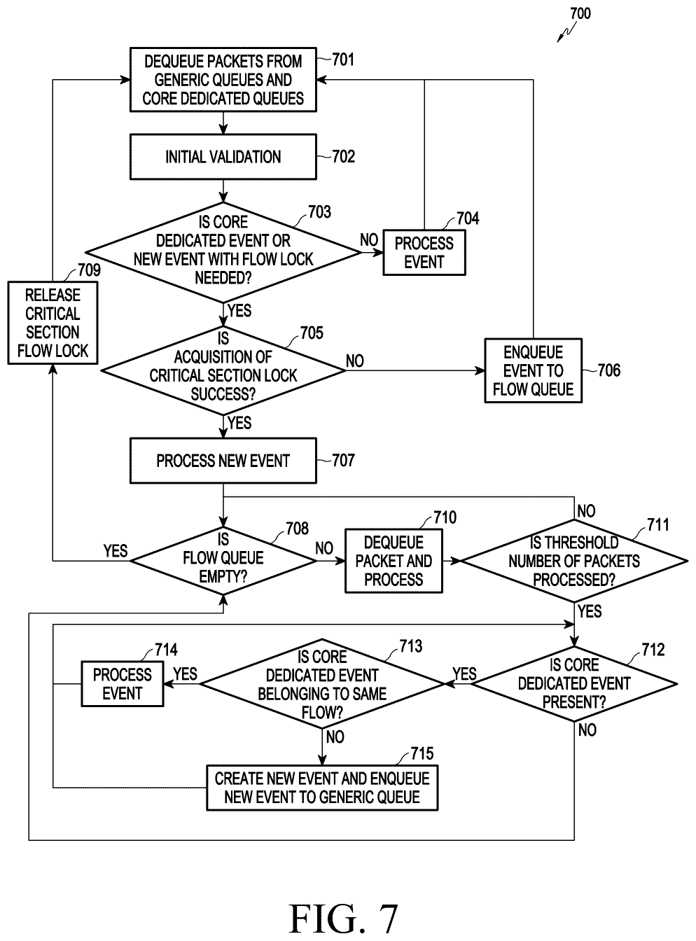

FIG. 7 illustrates a flow diagram (700) of a method for the data packet flow distribution in the multi-core processor (130) by processing an intermediate dedicated event, according to an embodiment of the disclosure.

At operation 701, the flow processing controller (110) dequeues and receives the packets from the generic queue and the core dedicated queues. At operation 702, the flow processing controller (110) performs the initial validation of the packets by identifying to which flow the packet belongs to. At operation 703, the flow processing controller (110) determines whether the received packet is the core dedicated event or the new event with flow lock needed. At operation 704, the flow processing controller (110) configures the core to process the received packet when the received packet is not the core dedicated event or the new event with flow lock requirement, and continues to perform 701. At operation 705, the flow processing controller (110) determines whether the acquisition of the critical section flow lock by the core is success or failure when determining that the flow lock is needed. At operation 706, the flow processing controller (110) enqueues the event to the flow queue when the critical section flow lock is failure, and continues to perform 701.

At operation 707, the flow processing controller (110) detects the new event and configures the core to processes the new event and checks when the acquisition of the critical section flow lock by the core is success.

At operation 708, the flow processing controller (110) check whether the flow queue is empty. At operation 709, the flow processing controller (110) releases the critical section flow lock when the flow queue is empty. At operations 710, and 711, the flow processing controller (110) dequeues and processes the packets from flow queue one by one until the flow queue is empty or the threshold number of packets is processed when the flow queue is not empty. At operation 712, if the threshold number of packets is processed, the flow processing controller (110) checks for the core dedicated event one by one until no such event is pending to be processed. At operation 713, the flow processing controller (110) checks whether the core dedicated event belonging to same flow. At operation 714, if the core dedicated event belongs to the same flow, then the flow processing controller (110) processes the core dedicated event. At operation 715, if the core dedicated event is not belonging to the same flow, then the flow processing controller (110) creates the new flow specific event and adds the new flow specific event to the generic queue to be processed by other available cores. The flow processing controller (110) performs the operation 708, to check and further process packet or events from flow queue.

The various actions, acts, blocks, operations, or the like in the flow diagram (300, 400, 600, and 700) may be performed in the order presented, in a different order, or simultaneously. Further, in some embodiments, some of the actions, acts, blocks, operations, or the like may be omitted, added, modified, skipped, or the like without departing from the scope of the disclosure.

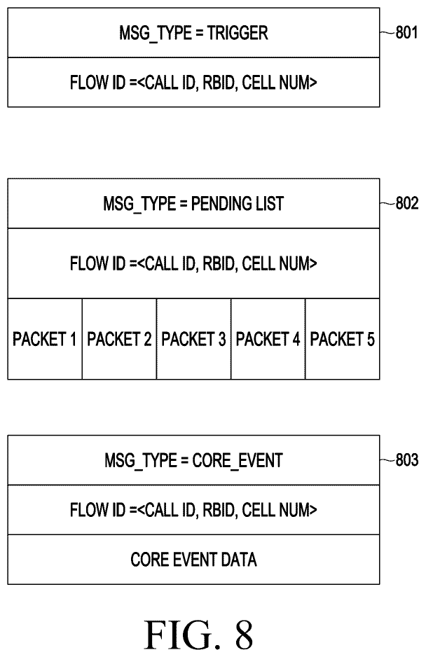

FIG. 8 illustrates examples for a trigger packet, a pending packet list, and a new flow specific event, according to an embodiment of the disclosure. Notation 801 is an example of the trigger packet. Notation 802 is an example of the pending packet list. Notation 803 is an example of the new flow specific event.

The embodiments disclosed herein may be implemented using at least one hardware device to control the elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for data packet flow distribution in a multi-core processor by an electronic device, the method comprising:
receiving, by the electronic device, at least one data packet to be processed by the multi-core processor;
determining, by the electronic device, whether a flow lock of a critical section of a data flow is acquired at a core of the multi-core processor;
determining, by the electronic device, whether a threshold number of data packet from a flow queue is processed at the core upon successful flow lock acquisition;
determining, by the electronic device, pending data packet to be processed in the flow queue upon processing the threshold number of data packet from the flow queue;
creating, by the electronic device, a new trigger packet or event upon determining the pending data packet to be processed in the flow queue;
releasing, by the electronic device, the flow lock of the critical section; and
enqueuing, by the electronic device, the new trigger packet or event to a generic queue to be processed by other cores of the multi-core processor.

2. The method of claim 1, wherein cores of the multi-core processor parallelly process the data packet of the data flow from the flow queue.

3. The method of claim 1, wherein the threshold number of data packet is configured based on a criticality of core specific events and average per packet processing cycles.

4. The method of claim 1,
wherein the new trigger packet or the event is a buffer comprising a message of a type as trigger,
wherein the message or the buffer comprising a flow identifier, and
wherein the flow lock acquisition and the processing of the threshold number of data packet of the data flow from the flow queue comprises:
determining, by the electronic device, whether the flow lock can be acquired based on flow identifiers in a new event or packet or a trigger packet or event,
determining, by the electronic device, whether the received data packet is the new event or packet or the trigger packet or event,
dropping, by the electronic device, the received data packet upon failure to acquire the flow lock after determining that the received data packets is the trigger packet or event, and
processing, by the electronic device, the received data packet upon successful flow lock acquisition after determining that the received data packet is the new event or packet or the trigger packet or event.

5. The method of claim 4, wherein the processing, by the electronic device, of the received data packet upon successful flow lock acquisition after determining that the received data packet is the new event or packet comprises:
enqueuing the new event or packet to a tail end of the flow queue upon determining that the flow queue is not empty;
processing the new event or packet upon determining that the flow queue is empty; and
dequeuing and processing the data packet from the flow queue one by one till the threshold number of data packet is processed or the flow queue is empty.

6. The method of claim 4, wherein the processing, by the electronic device, of the received data packet upon successful flow lock acquisition after determining that the received data packet is the trigger packet or event comprises:
determining, by the electronic device a data flow from the new trigger packet or event;
dequeuing, by the electronic device, the data packet from the flow queue one by one; and
processing, by the electronic device, the data packet from the flow queue one by one till the threshold number of data packet are processed or the flow queue is empty.

7. The method of claim 4, wherein the processing, by the electronic device, of the received data packet comprises:
creating, by the electronic device, a new trigger event with the flow identifier after processing the threshold number of data packet upon determining that the flow queue is not empty;
releasing, by the electronic device, the flow lock of the critical section; and
enqueuing, by the electronic device, the new trigger packet or event to a generic queue to be processed by other cores of the multi-core processor.

8. The method of claim 1,
wherein the new trigger packet or event is a received data packet comprising a pending packet or event list with a flow identifier, and
wherein the flow lock acquisition and the processing of the threshold number of data packet of the data flow from the flow queue comprises:
determining, by the electronic device, whether the received data packet is a new packet or event or a trigger packet or event,
determining, by the electronic device, whether the flow lock is acquired based on the flow identifier in the received trigger packet or event, and
processing, by the electronic device, the received trigger packet or event after determining that the received data packet is the trigger packet or event or a new packet or event.

9. The method of claim 8, wherein the processing, by the electronic device, of the received trigger packet or event after determining that the received data packet is the trigger packet or event comprises:
enqueuing pending data packets or events from the pending packet or event list to beginning of the flow queue upon failure to acquire the flow lock; and
processing the received trigger packet or event, enqueuing the processed trigger packet or event in the pending packet or event list to the beginning of the flow queue and processing one by one from the flow queue till the threshold number of data packet is processed or the flow queue is empty upon successful flow lock acquisition.

10. The method of claim 8, wherein the processing, by the electronic device, of the received data packet after determining that the received data packet is the new packet or event comprises:
processing, by the electronic device, the received data packet upon successful flow lock acquisition; and
processing one by one from the flow queue till the threshold number of packet is processed or the flow queue is empty upon successful flow lock acquisition.

11. The method of claim 8, wherein the processing, by the electronic device comprises:
creating, by the electronic device, a new trigger event with the pending packet or event list and a flow identifier after processing the threshold number of data packet upon determining that the flow queue is not empty;
releasing, by the electronic device, the flow lock of the critical section; and
enqueuing, by the electronic device, the new trigger packet or event to the generic queue to be processed by other cores of the multi-core processor.

12. The method of claim 1, wherein the determining, by the electronic device, of whether the threshold number of data packet from the flow queue is processed at the core upon successful flow lock acquisition comprises:
determining, by the electronic device, that the threshold number of data packets are processed;
dequeuing, by the electronic device, core-specific events or time-critical events from the flow queue;
determining, by the electronic device, corresponding flow of the obtained events;
enqueuing, by the electronic device, the obtained events to the generic queue upon determining that the obtained events belonging to a different flow;
processing, by the electronic device, the obtained events, upon determining that the obtained events belonging to same flow;
determining, by the electronic device, a number of data packet in the flow queue;
dequeuing, by the electronic device, the data packet from the flow queue until the flow queue is empty; and
processing, by the electronic device, the data packet.

13. The method of claim 1, wherein all enqueues and dequeues to the flow queue are done after acquiring the flow lock.

14. An electronic device for data packet flow distribution in at least one multi-core processor, the electronic device comprises:
memory, comprising one or more storage media, storing instructions;
the at least one multi-core processor communicatively coupled to the memory; and
a flow processing controller, coupled to the memory and the at least one multi-core processor,
wherein the instructions, when executed by the at least one multi-core processor individually or collectively, cause the electronic device to:
receive at least one data packet to be processed by the at least one multi-core processor,
determine whether a flow lock of a critical section of a data flow is acquired at a core of the at least one multi-core processor,
determine whether a threshold number of data packet from a flow queue is processed at the core upon successful flow lock acquisition,
determine pending data packet to be processed in the flow queue upon processing the threshold number of data packet from the flow queue,
create a new trigger packet or event upon determining the pending data packet to be processed in the flow queue,
release the flow lock of the critical section, and
enqueue the new trigger packet or event to a generic queue to be processed by other cores of the at least one multi-core processor.

15. The electronic device of claim 14,
wherein cores of the at least one multi-core processor parallelly process the data packet of the data flow from the flow queue, and
wherein the threshold number of data packet is configured based on a criticality of core specific events and average per packet processing cycles.

16. The electronic device of claim 14,
wherein the new trigger packet or the event is a buffer comprising a message of a type as trigger,
wherein the message or the buffer comprising a flow identifier, and
wherein the instructions, when executed by the at least one multi-core processor individually or collectively cause the electronic device to determine the flow lock acquisition and process the threshold number of data packet of the data flow from the flow queue, further cause the electronic device to:
determine, by the electronic device, whether the flow lock can be acquired based on flow identifiers in a new event or packet or a trigger packet or event,
determine, by the electronic device, whether the received data packet is the new event or packet or the trigger packet or event,
drop, by the electronic device, the received data packet upon failure to acquire the flow lock after determining that the received data packets is the trigger packet or event, and
process, by the electronic device, the received data packet upon successful flow lock acquisition after determining that the received data packet is the new event or packet or the trigger packet or event.

17. The electronic device of claim 16, wherein the instructions, when executed by the at least one multi-core processor individually or collectively cause the electronic device to process the received data packet upon successful flow lock acquisition after determining that the received data packet is the new event or packet, further cause the electronic device to:
enqueue the new event or packet to a tail end of the flow queue upon determining that the flow queue is not empty;
process the new event or packet upon determining that the flow queue is empty; and
dequeue and processing the data packet from the flow queue one by one till the threshold number of data packet is processed or the flow queue is empty.

18. The electronic device of claim 16, wherein the instructions, when executed by the at least one multi-core processor individually or collectively cause the electronic device to process the received data packet upon successful flow lock acquisition after determining that the received data packet is the trigger packet or even, further cause the electronic device to:
determine, by the electronic device a data flow from the new trigger packet or event;
dequeue, by the electronic device, the data packet from the flow queue one by one; and
process, by the electronic device, the data packet from the flow queue one by one till the threshold number of data packet are processed or the flow queue is empty.

19. The electronic device of claim 14, wherein the instructions, when executed by the one or more processors individually or collectively, further cause the electronic device to:
determine whether the received packet is a new event or a core dedicated event,
process a pending list when the received packet is not the new event or the core dedicated event.

20. One or more non-transitory computer-readable storage media storing one or more computer programs including computer-executable instructions that, when executed by at least one processor of an electronic device individually or collectively, cause the electronic device to perform operations, the operations comprising:
receiving at least one data packet to be processed by a multi-core processor;
determining whether a flow lock of a critical section of a data flow is acquired at a core of the multi-core processor;
determining whether a threshold number of data packet from a flow queue is processed at the core upon successful flow lock acquisition;
determining pending data packet to be processed in the flow queue upon processing the threshold number of data packet from the flow queue;
creating a new trigger packet or event upon determining the pending data packet to be processed in the flow queue;
releasing the flow lock of the critical section; and
enqueuing the new trigger packet or event to a generic queue to be processed by other cores of the multi-core processor.
